(19) United States
(12) Patent Application Publication
(10) Pub. No.: US 2016/0260345 A1
(43) Pub. Date: Sep. 8, 2016

(54) MULTISENSORY PHONEMOLOGICAL AWARENESS METHOD

(71) Applicant: Jane Milan, Napa, CA (US)

(72) Inventor: Jane Milan, Napa, CA (US)

(21) Appl. No.: 14/544,906

(22) Filed: Mar. 6, 2015

(51) Int. Cl. G09B 17/00

(52) U.S. Cl. CPC G09B 17/00

(57) ABSTRACT

A phonetically based auditory conceptualization method and system, whereby a combination of integrated oral motor picture cards, tracking mats, sound dots, and multicolored blocks, may be used to teach persons with neurological based learning differences such as dyslexia to: perceive, manipulate, and conceptualize phonemes within spoken words at the syllabic level; and to facilitate the allocation of said phonemes into the reading and spelling of monosyllabic and multisyllabic words.

### ACKNOWLEDGMENT OF GOVERNMENT SUPPORT

This invention was not developed with any type of government support. The government has no rights in applicant's invention.

### FIELD OF THE INVENTION

The invention pertains to the field of phonemic reading, spelling and comprehension remediation for persons with cognitive disabilities such as dyslexia.

### REFERENCE TO RELATED APPLICATIONS

This application is an original first filing; no provisional, continuation or other document has been filed with the United States Patent & Trademark Office by applicant pertaining to this subject matter.

### BACKGROUND OF THE INVENTION

Most spelling teaching methods for dyslexic students or students with similar learning disabilities on the market today start students learning how to read and spell with the assumption they already have some level of phonemic awareness. Phonemic awareness is the best predictor for reading and spelling success or failure.

Nearly all of the current, marketed, spelling programs are either based on “invented spelling,” visual memorization, explicit, logical phonetic instruction, or a combination there of. Some spelling programs consider any type of physical movement while spelling as “multi-sensory.”

This multi-sensory, phonological awareness program, serves as the foundation to teach students to perceive, conceptualize, sequence and manipulate individual phonemes within the spoken syllable. It has the possibilities of being used as a stand-alone program as well, but is best used as a primer for an Orton-Gillingham based reading and spelling program The syllable patterns used should for reading and spelling nonsense should follow the basic pronunciation and spelling patterns of the English language for words that are single syllable and multi-syllabic. As a stand-alone program, Applicant's method is capable of teaching spelling at a basic phoneme to grapheme level after phonemic awareness has been mastered.

The Orton Gillingham approach is a language based, multisensory, structured, sequential, cognitive and flexible teaching practice. It is a method of teaching phonemic awareness to the target students such as Applicant assists, is the foundation for success in teaching students with dyslexic or other cognitive challenges, comprising essentially the following steps.

Phonemic awareness is the first step. A student must learn how to listen to a single syllable or word and perceive it as individual phonemes. He or she must also be able to hear the individual sounds and blend them into a word. The students must also be able to change sounds, delete sounds, and compare sounds—all in their head without the use of letters. These skills are easiest to learn before exposure to printed letters and are not considered to be based on phonics.

After students perceive, sequence, conceptualize and manipulated spoken phonemes, the practitioner proceeds to phoneme/grapheme correspondence as the next step. Phoneme/grapheme correspondence is the relationship between sounds and letters. The alphabetic principal and positive letter recognition is essential for solid understanding of speech. It can be translated into words by use of the alphabetic writing system. It is also important for students to know that the letters on paper can be turned into spoken word or speech. Once a solid foundation for phoneme/grapheme correspondence is developed, the skills of auditory blending and segmenting phonemes can be applied to the blending and segmenting of letters (graphemes). This is the beginning of phonics. A student must learn which sounds are represented by which letter(s), and how to blend those letters into single-syllable words.

The six types of syllables that compose English words are taught next. If students know what type of syllable they are hearing and looking at, they will know what sound the vowel represents. Conversely, when they hear a vowel sound, they'll know how the syllable representing that sound must be spelled.

Probabilities and rules of language for each syllable are taught next in sequence. The English language provides several ways to spell the same sounds. For example, the sound “SHUN” can be spelled either TION, SION, or CION. The sound of a “J” at the end of a word can be spelled GE or DGE. Dyslexic students need to be explicitly taught these rules and probabilities.

Next the basic syllable rules are taught using, roots and affixes as well as morphology to expand the student's vocabulary and ability to comprehend (and spell) unfamiliar words. For instance, once a student has been taught that the Latin root TRACT means pull and a student knows the various Latin affixes, the student can figure out that retract means pull again, contract means pull together, subtract means pull away (or pull under), while tractor means a machine that pulls.

Research has shown that dyslexic people who use all of their senses when they learn (visual, auditory, tactile, and kinesthetic) are better able to store and retrieve the information. So a beginning dyslexic student might see the letter A, say its name and sound, and write it in the air—all at the same time. This approach is called “Simultaneous Multisensory Instruction”.

Instruction for dyslexic students must be much more intense and offer much more practice than for regular readers. This approach is called “Instruction with Ample Practice”.

Dyslexic students do not intuit anything about written language. They must be taught directly and explicitly each and every rule that governs written words. They must be taught one rule at a time and practice it until it is stable in both reading and spelling before being introduced to a new rule. This approach is termed “Direct, Explicit Instruction”.

By the time most dyslexic students are identified, they are usually quite confused by written language. They must be taken back to the very beginning of the learning process in order to create a solid foundation with no learning gaps. They must be instructed in the logic behind language by presenting one rule at a time and practicing it until the student can automatically and fluently apply that rule both when reading and spelling. Learned rules must be woven continuously with previously learned rules into current lessons to keep them fresh and solid. The system must make logical sense to such students from the first lesson through the last. This approach is called “Systematic and Cumulative” instruction.

According to Margaret Byrd Rawson, a former President of The Orton Dyslexia Society (the precursor to The International Dyslexia Association),
“Dyslexic students need a different approach to learning language from that employed in most classrooms. They need to be taught, slowly and thoroughly, the basic elements of their language—the sounds and the letters, which represent them—and how to put these together and take them apart. They have to have lots of practice in having their writing hands, eyes, ears, and voices working together for the conscious organization and retention of their learning.”

Following that logic, dyslexic students must be taught both how to take individual letters or sounds and put them together to form a word (synthetic) as well as how to look at a long word and break it into smaller pieces (analytic). Both synthetic and analytic phonics must be taught all the time. This approach is termed “Synthetic and Analytic”.

Teachers of such students must continuously assess the student's understanding of, and ability to apply, the rules. The teacher must ensure the student isn't simply recognizing a pattern and blindly applying it. And when a previously-taught rule is discovered, it must be retaught. This approach is termed “Diagnostic Teaching”.

In the prior art, present practice finds the two best predictors of early reading success are alphabetic principle and phonemic awareness and the lack of phonemic awareness is the most powerful determinant of the likelihood of failure to read. Phonemic awareness has been shown to be a very powerful predictor of later reading achievement. In fact, it is a better predictor than more global measures such as IQ or general language proficiency.

Phonemic Awareness is more highly related to reading than tests of general intelligence, reading readiness, and listening comprehension.

Importantly, the most comprehensive reading program explicitly teaches about the sounds of language. It teaches children that words can be broken up into these smaller units of language, that the letters represent this unit of language—phonics.

What is needed then, is a more structured and comprehensive method of teaching phonemic awareness without the added difficulty of letters, but rather, sounds. With such a program, a dyslexic or other similarly challenged student may achieve the necessary foundation in preparation entering the next phase program such as an Orton-Gillingham program in order to enhance the probability of success.

### SUMMARY OF THE INVENTION

Applicant's teaching method develops phonemic awareness at the auditory, visual, kinesthetic and multi-sensory level. The method develops a student's ability to hear, feel, touch and discriminate individual sounds within words and syllables. Furthermore, the method teaches students how to determine the sameness and differentness of sounds. Another feature of the method is the development of the foundation for spelling and reading at an auditory level. Applicant's method is not a phonics program, but rather the step before phonics should be introduced. Phonemic awareness is the best predictor for reading and spelling success or failure. Applicant's method provides the aforementioned foundation needed for success in reading and spelling.

Applicant's method comprises two predominant beginning parts: a phoneme awareness unit which teaches students to “track” three sounds and a spelling sound dot system that visually anchors sounds to paper by the use of “tracking felts” or, alternatively, “tracking mats”.

Applicant's method of instructing dyslexic student in phonemic awareness begins with the introduction of picture cards that depict three specific vowel sounds with correlating mouth movements.

It should be noted that in the case of students with Attention Deficit Hyperactivity Disorder, or ADHD, it may be necessary at the very beginning of training, to prevent the student from immediately grabbing, selecting, or placing mouth pictures, sound dots or sound blocks until a recognition or perception of the “sameness” or “difference” of that specific sound and the ability to delete or switch that sound is demonstrated sufficiently to the teacher. Without this first step, the randomness of such a student's initial inclinations inhibits the structured introduction of the concept and exercises of phonemic awareness.

The student is asked to mimic or copy the mouth movements shown on the picture cards, but is not asked to make any sounds. Once the student can successfully mimic three picture cards, sounds are demonstrated for each. The student and teacher practice physically copying the picture card and making the appropriate sound. A tracking mat is introduced and the concept of a sound dot is introduced. The sound dot concept and usage will serve as the foundation for a “spelling dot system”. The sound dots become spelling dots during the progression from phoneme/grapheme stage to a later phonics stage. Another tracking mat is introduced as the foundation for tracking three sounds. For example, the teacher places a picture on an anchor point or area represented by a line for convenience and the student is instructed to touch the sound dot and make the sound that correlates to the picture card. The teacher then changes the sound and asks student to touch the sound dot and repeat the new sound. The student is asked if the new sound and new mouth movement match the picture card. The student may check his or her mouth position in a mirror or simply confirm that he or she feels the difference. The student is typically asked to find a picture matching the new sound. The student replaces the old picture with a new picture matching his or her mouth. This process is repeated until the student has mastered the ability to recognize the difference between the various sounds, the appropriate mouth position and finally, the picture cards representing the appropriate mouth position.

This technique is effective in the building of phonemic awareness of sounds in the spoken word as well as phonemic correspondence (monosyllabic words) and further teaches syllables supporting the foundation of later Orton-Gillingham remediation.

The process utilizes the following tools or props:

Sensory, employing “word felts” or word tracking mats of different colors and textures, typically substantially rectangular with the best mode of the invention employing felts approximately 4″×4″ in size and representing a word, but any suitable shape providing a suitable surface may be used.

Syllable felts (or mats—the terms may be used interchangeably) of different colors, typically substantially rectangular with the best mode of the invention including a large “X” thereon in black or white and in the best mode of the invention, sized approximately 2″×2″, in any case, small enough to be used with the word felt and representing a syllable.

Sound felts representing sound contained in a syllable, round in the best mode of the invention and useful in conjunction with the word and syllable felts and individual sounds within a syllable are also used.

For example, a mat surface of felt may have an area where a picture of an object may be located proximate thereto; for example a picture of a duck. The syllable felt, is placed near the picture and three sound dots may be positioned near the syllable felt thereby representing the two consonant sounds of /d/ and for the “ck” sound of /k/, and the single vowel sound of the /u/ thereby comprising the pronunciation of the word “duck”, the subject of the picture.

Another prop or tool is the sight word felt specifically colored for use as “sight” words (non-phonetic) spelled by the teacher, not the student. The sight words may be later taught as “camera words”. To do so, sight words are placed on a small camera picture and the student is taught that the selected word is a picture and therefore cannot be read; rather the word must be recognized as a picture.

In this instance, no letters are employed. Each word felt is a chosen word, supported by a picture. A teacher lays out a word felt and places a picture on the felt. The student takes the syllable felt and places it under the word felt clapping 1 time for each syllable. To progress, the student takes the multicolored sound dots and sequences the sounds by placing the 1^{st} dot on the syllable felt and saying the sound. The student places the 2^{nd} sound dot on the syllable saying the second sound. If a third syllable is being taught, he student places the 3^{rd} sound dot on the syllable and says the 3^{rd} sound. Ultimately, the student touches each sound dot, saying the corresponding sound. The teacher may point to each sound out of sequence prompting the student to say the corresponding sounds. To complete this part of the exercise, the teacher makes a “blending swoop” motion with his or her fingers on the table defining a “read motion.” The student blends the sounds by reading them and is asked to use the word in a sentence. In a second level the teacher says the word without a visual demonstration. The student “claps” the syllable and then lays down the appropriate sound dots in proper order. The two processes are repeated to strengthen the student's ability to correlate the sounds with the syllables.

In the previous example the sound dots may take several physical forms, but in a preferred embodiment, said sound dots are constructed of wood in a substantially round shape resembling a “dot.”

In a later stage, the same procedure is used to correlated vowels (denoted by “V”) with consonants (denoted by “C”) in combinations of VC-CV-CVC-CCV-VCC, using nonsensical words. This is a system whereby the teaching is “scaffolded” in order to take the student from monosyllabic words to multisyllabic words.

The sound dot system promotes phonemic awareness of sounds within the spoken syllable and later supports the introduction of the corresponding grapheme to the isolated phoneme. In the advanced stages of the method this foundation will lead to a correlation between the two particularly with single syllable words. In this way, syllables may be taught along with rules and probabilities as well as roots and affixes.

The continual use of simultaneous multisensory instruction performed in an intense session with ample practice serves to reinforce the learning until a satisfactory amount of correct repetitions demonstrates that the student has learned the various sounds and syllables.

Direct explicit instruction of one rule at a time, with systematic and cumulative review will result in stable performance on the part of the student.

The synthetic and analytic mode of building words, breaking them down, coupled with diagnostic teaching will assure the quality of instruction and stability of the repeatable and correct knowledge gain of the student.

Once this technique has advanced, the next technique, utilizing tracking mats may be applied.

Applicant's second process or technique utilizes “tracking mats”. Tracking mats are useful when a student cannot achieve success in the Orton-Gillingham method. Tracking mats provide a visual/special/kinesthetic placement for phonemes within a spoken syllable. The mats offer a predesigned sequence of steps for isolating individual phonemes, blending those phonemes slowly through the “swoop” and then quickly, “reading” the phonemes fluently. After the student “reads” the word, the student is asked to describe the word or use it in a sentence. This confirms the student's auditory perceptions, conceptualization and comprehension of the individual phonemes as real words

The objective is for the student to track 3 sounds with picture cards in 8-12 sessions & to track using another technique, multicolored blocks, in 12-18 sessions.

Fluency is the ability to isolate, delete, insert, substitute, switch & automatically segment phonemes in CVC/CCV/VCC patterns using the above convention for “consonant” and “vowel.”

Success is achieved when the student can track three sounds with picture cards in eight to twelve sessions and can similarly track 3 sounds with multicolored blocks in twelve to eighteen sessions.

Fluency is achieved when the student exhibits the ability to isolate, delete insert, substitute, switch and segment phonemes in CVC/CVV/VCC patterns or can show competence by an auditory conceptualization test such as the one provided in this method, the Barton Screening Part C or the Lindamood Auditory Conceptualization Test.

Applicant's method can be exemplified by the technique described immediately below.

It is important to note that upon the first meeting of student and teacher, the teacher explains the function of the brain in processing sounds, reading words and in spelling. The teacher asks the student if he or she can name one thing a person (physically and mentally) uses to read. After one such example is mentioned by the student, the teacher uses the Socratic method of questioning to help the student discover for himself or herself the pieces of the body which are employed in processing sounds. These can include parts of the body as simple as eyes, ears, the mouth, tongue, teeth, jaw, throat, voice box, nose, and on some higher levels, the relevant lobes of the brain. This cognitive exercise serves to explain the physical process of reading to the student.

After this orientation to the body and the student's grasp of the relation of the body to sound, the student is shown a mouth movement either for a sound and asked if he or she can perform the same, a different or a similar one. This demonstration of mouth shape and movement may be performed live by the teacher or in another embodiment of Applicants, employing a video or even a hologram of the teacher, an unknown third party or even the student himself or herself. The teacher guesses if the student is doing the same, different or similar shape and movement. The teacher then switches and has the student pick a mouth movement and the teacher performs the same, a different or a similar mouth movement. The student is encouraged to guess which mouth shape and sound the teacher is making. As the exercise is performed the teacher finds opportunities to reinforce the student's abilities or re-teach a concept if necessary. Because of the three options employed the student will never “get it wrong”. The teacher the responsibility to point out what the student is doing right, then redirect, re-teach or demonstrate what was not correct. The teacher should never categorize the student's performance in a negative light. Effective techniques of the teacher to reinforce correct performance include: praise for the smallest of things putting the student's activity in a positive light; asking the student to explain his or her answer or action positively; draw out the student's process of analysis; when an incorrect answer is given ask the student what led to his or her selection; and always assuming responsibility for an incorrect answer rather than the student.

Examples of reinforcement may include but not be limited to:

“I love the way you noticed the difference of those two colors.”

The teacher should use a statement similar to the previous example when the child is completely lost. The teacher can always find something the student did to point out as positive. This can include how the child pointed, smiled, stopped to think, changed their mind, looked at your face for reassurance, or simply responded.

Sample teacher responses could include for example those dialogue segments listed immediately below.

“Tell me more about why you think that.”

“I am not sure I understand why you think that. Can you give me more information?”

“That is an interesting way to think about that. Can I tell you how I see it?”

“Wow, I never saw it that way before. I have always seen it like this.”

“Thank you for sharing that. I would like to share with you how I imagine it.”

“Do you think it may be possible to see it like this?”

Such statements allow the student to not feel as if the answer is wrong, which will often shut them down emotionally. By always acknowledging what the student did correctly avoids such a problem and the teacher can always redirect the learning after.

If necessary to save the student's self-esteem the teacher should always consider saying to the student from among the following or other equivalent phraseology:

“I am so sorry I did a really bad job of teaching you how to” Or say, “I didn't do a good job explaining what I meant. May I say it a different way?” Or say, “I asked a really bad question. May I ask a better question, a different way?”

The teacher must take responsibility for every incorrect answer. The teacher must find what was done correctly before any error correction. Ultimately, the teacher must take responsibility for all learning issues. The attitude of the teacher should be that a wrong answer or performance is never the student's fault.

An example of the technique for sound tracking immediately follows.

The method nearly always begins with the three sounds with the largest discrepancy between them. /EE/-/O/-/OO/

After the three mouth movements have been placed on the table the teacher instructs the student to point to a mouth movement and to make his or her mouth look like the picture. The teacher points to one of the three cards and makes his or her mouth look like the card. Sounds are not yet employed.

After the teacher has modeled all three pictures, he or she asks the student to point to any card he or she wants and to make his or her mouth look like the picture. This allows the student to begin with the mouth card in which they are most confident.

After the student performs correctly the teacher should find something for which to praise the student. After having done so, the teacher encourages the student to continue.

After the student can correctly form the mouth movements for all three cards, then a card is chosen to introduce a sound.

The teacher might say for example, “You did such a good job with this mouth movement; I want to introduce to you the sound you will make after you make your mouth look like the card.”

This technique is applied with all three pictures.

The teacher then returns to the pointing activity, repeating, but adding in the sound each picture makes.

It is best to always instruct the student get their mouth in position before making the sound.

Once the student can perform correctly with all three pictures the teacher can take out the first “segment and blending” felt or mat.

Using the segment and blending felt, the teacher places one mouth card on the square mat. He or she explains to the student that the student will touch the “sound” button, make his or her mouth look like the picture and then make the sound. The student's finger needs to stay on the button the entire time.

The teacher then shows the student the green “go” button and the red “stop” button demonstrating how to touch the green go button, make the mouth movement and then show how the sound will slide along the illustrated “swoop”. Further, the sound will stop when the student's finger hits the red stop button. The action is always demonstrated before asking the student to perform.

After the student can do step one and two, the teacher shows the student the “race track” illustrated along the bottom of the mat. The teacher explains that the student's finger will stay on the start line until the student has his or her mouth in place. Once accomplished, the student will say the sound as fast as they can as their finger moves over the race way to the finish line.

The teacher continues to place the different mouth cards on the mat allowing the student plenty of practice time. The teacher uses this time to help with sounds or correct mouth positions. Some students will want to do the “swoop” extremely fast. The teacher should not ignore this, but in turn, slow them down. The student can be allowed to physically move the picture card along the swoop if needed to slow the motion and activity down. As soon as the correct tempo is achieved the teacher should return the picture to the square. This square will become a “chair” on the next mat.

If time permits, the teacher may pull out the “one sound-tracking mat” and provide the student with a hook for the next lesson.

At this juncture, according to Applicant's method, the teacher typically introduces the concept of chairs and what they represent. It is desired that the student see the line as a chair. The teacher should explain that only one person is allowed to sit in a chair at one time. School may be used as an example. The student and teacher discuss how people must get up out of their chair before someone else can sit down in that same chair.

The teacher may now employ a real chair to reinforce the concept and perform the following activity.

The teacher sits in the chair holding the large mouth movement card demonstrating to the student how he or she is sitting in this chair. The student is instructed to pick up one of the two remaining large cards and approach the chair. The student is told that that when the teacher get up, the student my sit down. The student is further told that only one mouth movement can be in the chair at a time. This activity will keep the student from trying to place a mouth card ON TOP of another mouth card. Many options are available to demonstrate that the student will need to make sure the person or sound is out of the chair before the new person or sound sits down. The teacher can make this activity fun for the student to reinforce the concept.

Next, one picture card is placed on the mat. The student is told that the teacher is going to either make his or her mouth look like this picture or not. If the teacher's mouth looks like the picture the student gives a thumbs up sign. If the mouth does not look like the picture, the student must “kick” the picture out and find the picture that does match the teacher's mouth. The teacher leaves his or her mouth in position for the entire time. Sounds are not used yet; only mouth movements. After several turns the student is offered an opportunity to be the teacher. The roles are not reversed.

This is the hook or lead-in for the next session.

In the next session the identical activities are repeated introducing more mouth cards. Some students can handle three more cards and some can handle only one. Professional judgment is important with the objective that the student is always set up for success.

Other sound cards are introduced methodically and representing the sounds in the language. It is important to note that if the student is having difficulty forming mouth movements, sounds should not yet be introduced for such movements. The focus on getting the mouth movement down before the sound is introduced is of paramount importance.

Continuing in accordance with Applicant's method, at this point a “segment and blending” mat may be introduced. This mat should be used this with all the sounds the student currently has. Utilizing the segment and blending mat achieves a certain level of muscle memory and should be used until the student can track three sounds.

Next, the teacher brings out the one sound-tracking mat with the picture of a chair on it and asks probing questions to assess the student's memory such as how many people can sit in the chair at a time, and what happens if a mouth position does not match the picture and whether two pictures can sit on top of each other in the chair.

The teacher can take the activity one step farther and tell the student that he or she is going to ask the student to find the card that matches the sound the teacher is making.

The teacher leaves his or her mouth open. The student locates the card and puts it in the chair to the praise of the teacher.

The student is prompted to change the card based on the sound the teacher makes with the appropriate mouth position. This is repeated numerous times.

The teacher may not let the student be the teacher and control the chairs. If it is too difficult for the student to remember, the student may simply hold the sound and mouth position until the teacher completes the switch.

Once the student can do this activity successfully and with stability, the teacher will stop the use of that particular mat for the day.

The objective is to blend picture cards with ease by the tenth session between the student and teacher.

Another exercise employs duplicate pictures. The teacher will have duplicates of several pictures on the table.

The teacher makes one sound instructing the student to repeat the sound and then find the picture card. The teacher has the student move the picture card to his or her body. This activity moving the correct picture to the student's body is repeated. Eventually the teacher praises the student and announces that with such an amazing job with one sound, the student will be introduced to two sounds.

The student is introduced to two related sounds such as “OO” or “O” and asked to identify each by its mouth picture. The student is then prompted to note the sameness or difference of the various sounds in order to distinguish and further reinforce the nuances of the mouth position and sounds. These repetitive actions teach the student substitution deletion and insertion with two sounds using picture cards.

The teacher may also introduce the student to a game, in the preferred embodiment named in the alternative, “Liar, Liar” or “My Word, Your Word. In the case where the teacher instructs the student to touch each picture card on his side and say each sound and informs student that his word is telling the truth and will not change. The teacher then explains that one of her pictures is “lying” and the student needs to identify the lying picture card on the teacher's side. The teacher instructs the student to touch and say each sound in his word and then the teacher immediately touches her own picture cards saying the each sound. This is repeated as many times as needed until the student can detect the liar. The student then removes the liar and places the correct picture or “truth teller” card in the correct spot. The teacher then says each sound starting at the left and asks the student if the sounds are the same or different. The teacher moves through each set of picture cards repeating the two sounds and asking if they are same or different. This procedure is performed regardless of the correctness or mistake of the student's choice. It reinforces the conceptualization of same verse/different verse.

It is important to note that other mats are available for use if the student is struggling and a remedial work is needed. Some students may not be ready for the full jump from one mat to another. It is possible to create other mats that may be used in such cases recognizing that the basic elements of: picture cards, sound dots, sound blocks, sound points for beginning and ending a sound, swoop lines, reading lines, anchoring areas or points etc., may be configured in appropriate combinations or subsets based on what specific difficulty the student is experiencing.

Under Applicant's method, a large number of options exist for the teacher to use different felts or mats with a student having difficulty with any level or combination of these techniques. It is incumbent on the teacher to recognize the concept with the student is struggling so as to revert to a more simple mat using the appropriate combination of elements to assure that mastery of that particular level is achieved before continuing to advance in level.

All of the above techniques including the sequencing of their application have been tested by Applicant with the target students and given the building nature of the various mats, sound dots and other sound-related components the students have demonstrated the ability to perceive, conceptualize, sequence and manipulate individual phonemes within the spoken syllable; all without the use of alphabetical letters or numbers.

### BRIEF DESCRIPTION OF THE DRAWINGS

FIG. 1 is a plan view of a reading felt or mat of Applicant's invention according to the preferred embodiment;

FIG. 2 is a plan view of a one sound basic spelling tracking felt or mat that is used with picture cards and then blocks mat of Applicant's invention in a simple configuration for use with a sound dot;

FIG. 3 is a plan view of a reading felt or mat of Applicant's invention in configuration to enable use of more than one sound dot or block;

FIG. 4 is a plan view of a spelling/tracking felt or mat of Applicant's invention;

FIG. 5 is a plan view of a reading felt or mat of Applicant's invention utilizing three sound picture cards, dots or sound blocks to teach the reading of a word;

FIG. 6 is a plan view of a large tracking mat or felt of Applicant's invention used to enable a student to form and spell words using picture cards, sound dots or sound blocks;

FIG. 7 is a plan view of a tracking felt or mat of Applicant's invention having three mouth pictures, then sound dots placed thereon; and

FIG. 8 is a plan view of a tracking mat of Applicant's invention used in a “my word: your word” exercise also known as the “Liar Liar” game for young students.

### DETAILED DESCRIPTION OF THE INVENTION

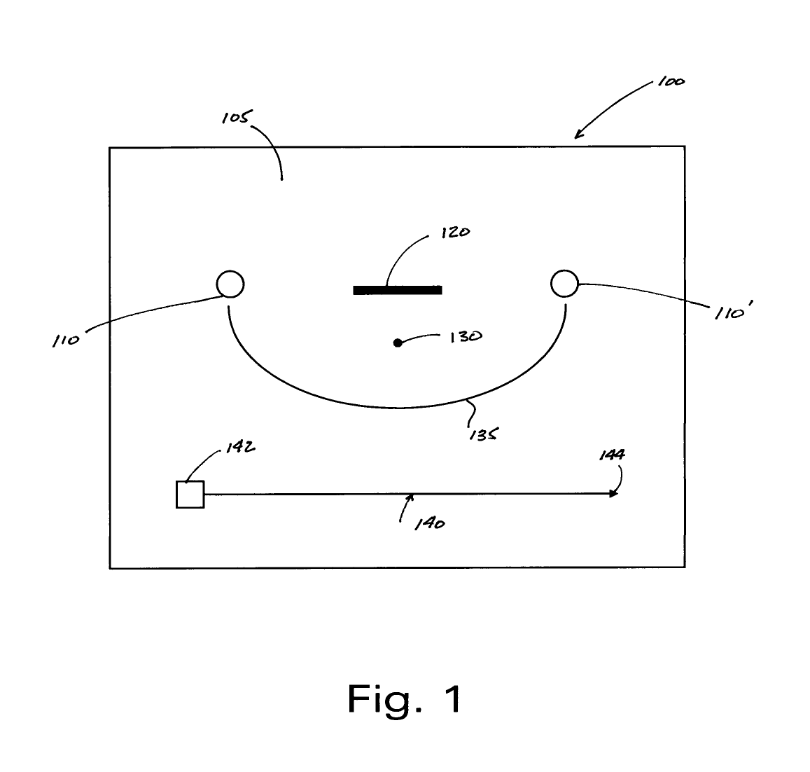

FIG. 1 depicts a reading or tracking mat 100 comprising a surface 105, said surface providing for the positioning of two sound points, 110 and 110′, said first sound point 110 typically of green color to indicate a “go” action and said second point 110′ typically of red color to indicate a “stop” or cessation action. These two sound points are relevant to anchor point 120, such that when a picture card, sound dot or sound block (neither of which is shown) is placed upon said anchor point 120 representing the sound to be practiced, a student may initiate the beginning of said sound represented by said sound point 110 and consequently expressing the conclusion of said sound represented by sound point 110′ according to which sound point a teacher focuses the student's attention upon or similarly, the student wishes to practice. Slap point 130, when touched by student or teacher (usually as the first part of the teaching exercise) prompts the student to express a rapid representation of the sound. A picture card is typically the initial tool. Sound dots or blocks come after sound association with picture cards are mastered for each mat.)

A sound block or dot (again, not shown) placed upon said anchor point 130. As swoop line 15 is employed as an additional exercise where the student touches sound point 110 (the “go” point), extending his hand along swoop line 135 to slowly form the sound with his or her mouth until he or she reaches sound point 110′ (the “stop” point). Reading line 140 when touched by student or teacher instigates a timed reading of said picture card sound dot or block, typically starting at the left of said reading line 140, comprising a starting point 142 at said reading line's leftmost and an ending point 144 at said reading line's rightmost, representing the express blending of the desired sound from beginning through any middle to the conclusion of said sound further correlative to sound points 110 and 110′ and representing the initiation and conclusion of the sound being taught (again, picture card sound dot or sound block not shown in this figure). The left to right motion of said reading line 140 reinforces the later conceptualization of reading from left to right. Reading line 140 may also be referred to as a “race track” as the student is encouraged to express the sound more rapidly in order to read, hence speak the sound.

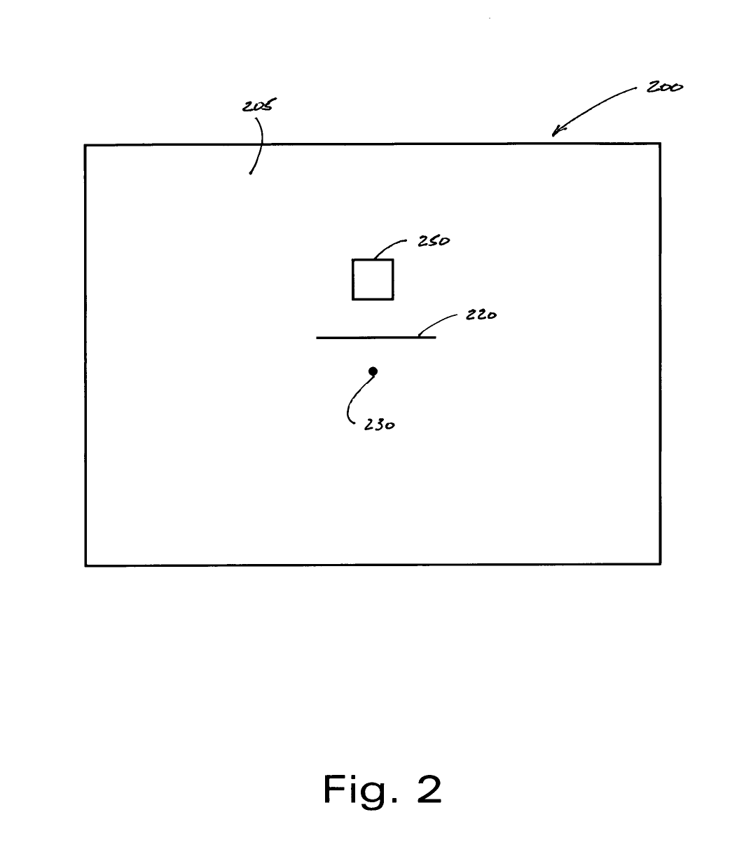

FIG. 2 depicts a very basic tracking mat 200 of Applicant's invention, comprising a mat surface 205, an anchor point 220 and a slap point 230. A card 250 comprising a card or photograph of a mouth position is placed proximate to anchor point 220 such that when slap point 230 is touched, a student purposefully mimics the mouth position on card or photograph 210, expressing the correlative sound. Card 250 may vary from mouth position to mouth position, representing differing correlative sounds said student may have been already been taught or new positions. Further, said card 210 may take the form of a photograph of the student's own mouth or even as a hologram of the student's or a third party's mouth thereby providing a dynamic or static representation of the position of the mouth and the correlative sound. In other exercises, sound dots or sound blocks may also be introduced to practice association utilizing this tracking mat.

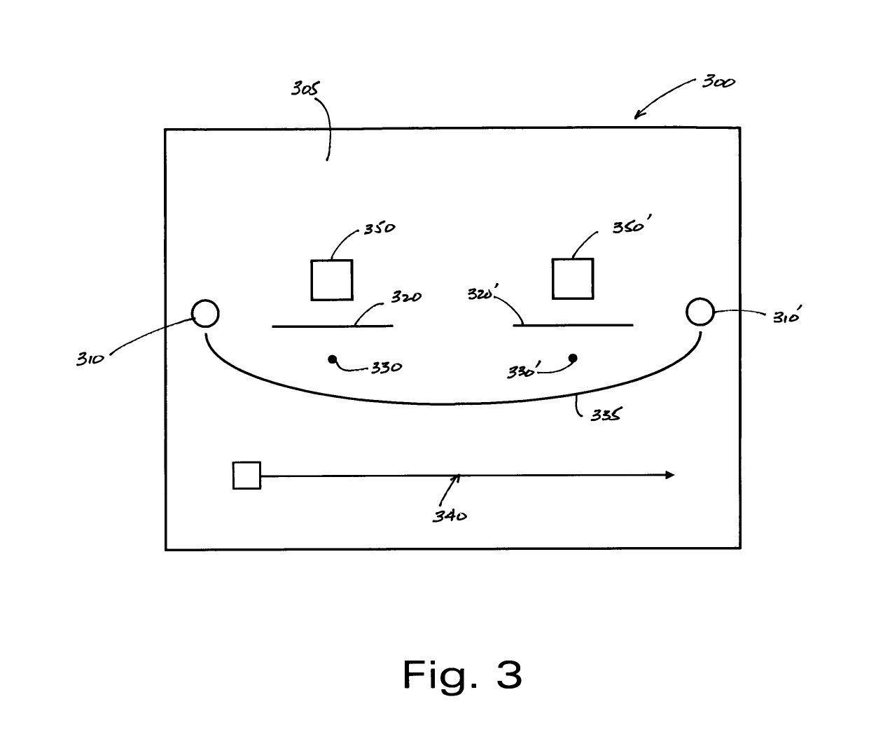

FIG. 3 depicts a reading tracking mat 300 comprising a surface 305, sound points 310 and 310′, anchor points 320 and 320′, slap points 330 and 330′, swoop line 35, reading line 340 and cards 350 and 350′. In one use of tracking mat 300, card 350 may represent a vowel and card 350′ may represent a consonant. As in tracking mats 100 and 200, in mat 300, said slap points 330 and 330′ may be focused upon for a student to initiate the correlative sounds on cards 50 and 350′ in rapid fashion. Similarly, swoop line 335 is employed to have the student deliberately form the mouth movements and sounds to produce the syllable desired. Consistent with the previous representation in FIG. 1, using reading line 340, a student may then blend together the sounds represented by cards 350 and 350′ reading the syllable comprising the vowel of sound card 350 with the consonant of sound card 350′.

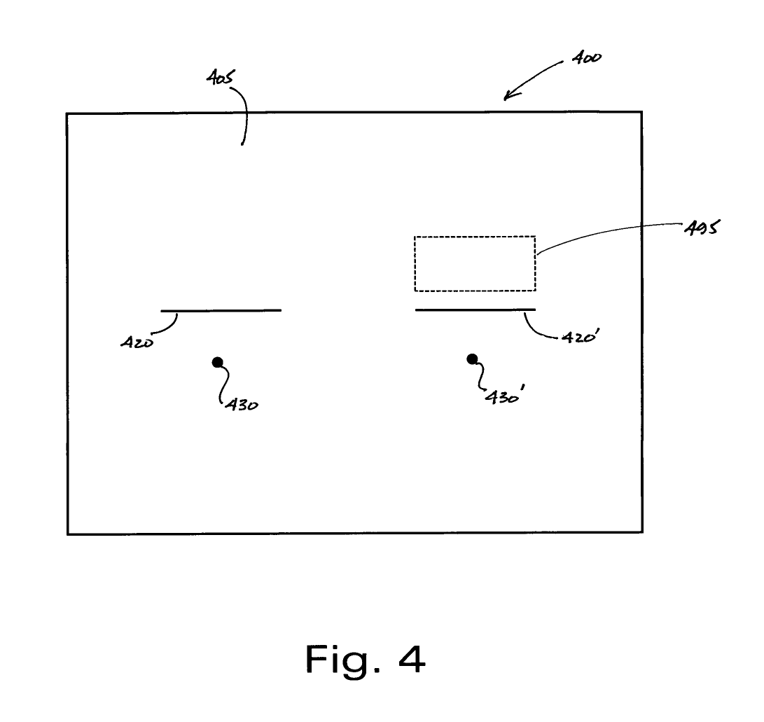

FIG. 4 depicts a tracking mat of Applicant's invention used primarily to teach the perception of the distinction of sounds, which is the foundation for spelling of words having only two sounds. This tracking mat shows essentially a map surface 405, two anchor points 420 and 420′ and two slap points 430 and 430′. Tracking mat 400 is distinguished from those tracking mats of FIGS. 1 and 3 in that tracking mat 400 contains no swoop or reading lines. Not shown are a variety of cards to pick from representing mouth positions or sounds. When various cards representing differing mouth positions are placed above anchor points 420 and 420′ as phantom card location 495 represents, the student conceptualizes the correlative sounds. By using tracking mat 400 sufficiently such that the auditory familiarity is achieved by the student, phonemes are ultimately associated with whatever two sound cards (not shown) are located above anchor points 430 and 430′ and the student may then progress to the use of sound dots to spell a word represented by said sound cards (not shown).

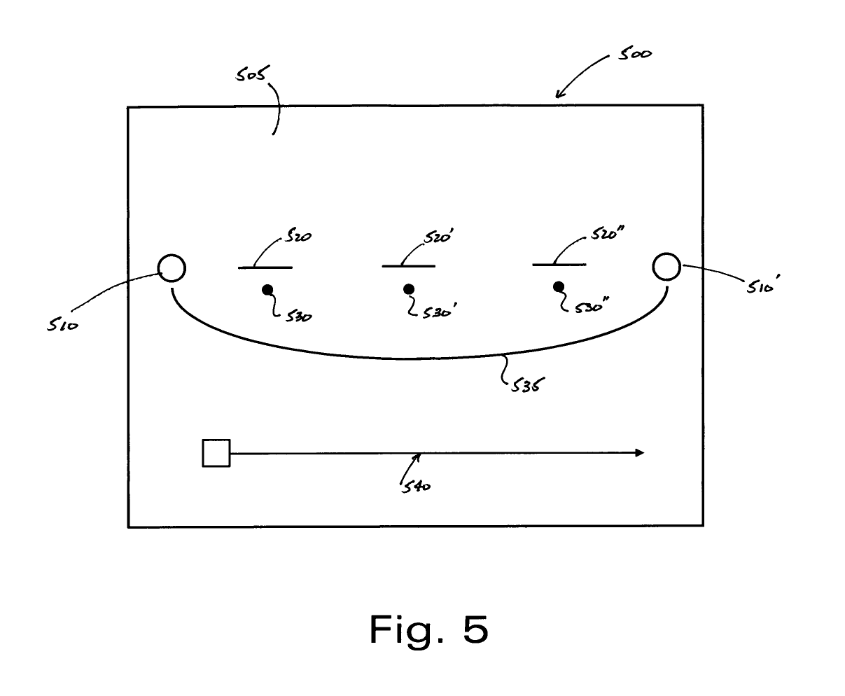

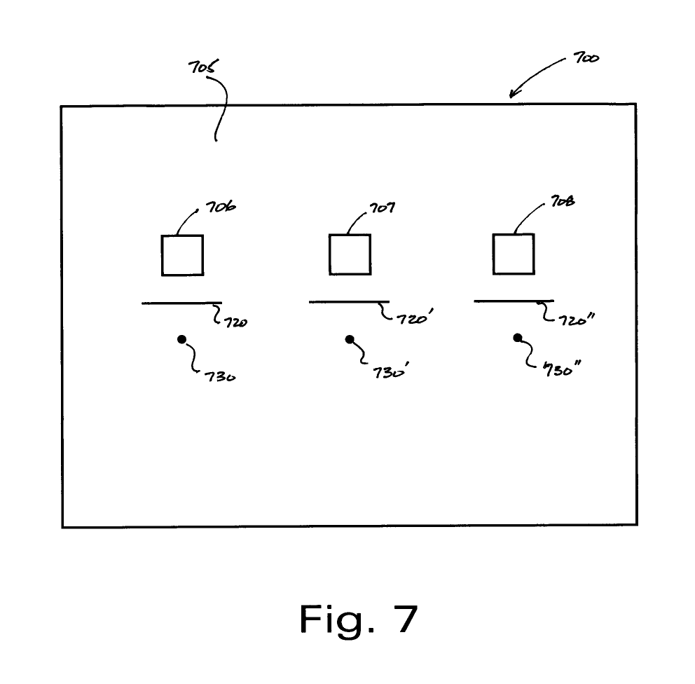

The tracking mat of FIG. 5 is similar to the tracking mats of FIGS. 1 and 3 in that tracing mat 500 comprises a mat surface 505, sound points 510 and 510′, but increases the number of anchor points to 3, comprising anchor points 520, 520′ and 520″. Similarly, mat 500 includes 3 slap points 530, 530′ and 530″ allowing a combination of pictures representing sounds of vowels or consonants to be positioned such that when swoop line 535 is employed, the student changes mouth positions consistent with sound cards as might be place above said anchor points 520, 520′ and 520″ deliberately making the corresponding sounds. Likewise, when reading line 540 is focused upon and used by the student, a three sound word may be read by the student in natural fashion without the more deliberate and perhaps even exaggerated mouthing associated with said swoop line 535. Likewise, slap points 530, 530′ an 530″ act consistent with the previous figures. Without reading line 540 or sound points 510 and 510′, this mat can operate as a spelling mat as shown in FIG. 4 and as will be depicted in FIG. 7.

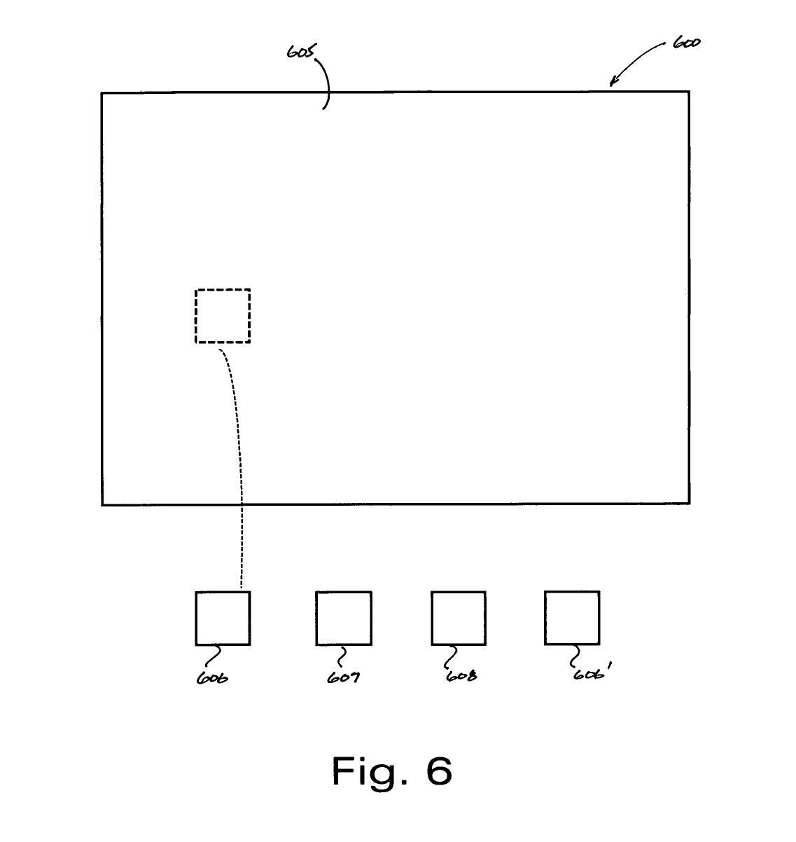

FIG. 6 departs somewhat from the tracking mats depicted in the previous figures. Here, large word felt 600 is provided more or less as a “canvas” whereupon a student may define a word by said felt through the process of placing colored sound dots 606, 607, 608 and 606′ onto said felt surface 605. Each of said colored sound dots represents a sound defined by the student. In FIG. 6, colored sound dots 606, 607 differ in color while colored sound dot 606′ is the same color as sound dot 606. In the case of Barton vowels, it is helpful to define colored blocks representing vowels as say, yellow, keeping uniformity of vowel sounds by having all vowels the same color. As an example, were colored sound dots arranged from left to right in sequence as sound dots 606, 607 and 606′ upon surface 605 and in the case where sound dot 606 represented /p/ and sound dot 607 was the vowel /o/ as in the word got sounding like ‘ah’, then the configuration of said sound dots would comprise the word “paw” by combining the sounds. With such a large word felt and plenty of colored sound dots which the student may define as sounds he or she wishes to employ, the forming of words through the conceptualization of their sounds and the correlation of the various vowels and consonants are many. Words may be so formed and the foundation for auditory conceptualization may be reinforced. Here, the end goal of the described example is to have the student react to the teacher's request to “show me “pop” (conventionally represented by the first and last sound dot being the same color to show “sameness” of the spelled phoneme). After success, the teacher may then show the student a picture of a mop or simply say “mop”, asking the student to show the relevant sound combination through either picture card (mouth position), sound dot or sound block. This tracking mat of FIG. 6 is typically used with a single syllable and in the fmal state of the method should be utilized in the conceptualization, manipulation and production within a series of nonsense syllables.

FIG. 7 depicts tracking mat 700 used to define a syllable comprised of three sounds. Upon mat surface 705 are placed: sound card 706 proximate to anchor point 720 and slap point 730; sound card 707 proximate to anchor point 720′ and slap point 730′; sound card 708 proximate to anchor point 720″ and slap point 730″. If sound card 706 is represented as the hard /g/ as in the word got sound card 707 is represented as the vowel /o/ with ‘ah’ sound, and sound card 708 is represented as the /v/ sound, the syllable “gov” would be formed. As in the previous figures, said anchor points and said slap points operate similarly to reinforce the learning and familiarization of the sounds and syllables.

While tracking mat 700 is generally employed to teach single syllables, it potentially may also represent a two syllable sound if said sound cards 706, 707 and 708 were sequenced from left to right represented in the vowel/consonant convention as V-C-V. For example, using only the two sound cards 707-708 (/o/-/v/), a syllable of 2 sounds is formed “ov”.

An important concept is that in all the previous figures employing mouth (or picture) cards sound dots, sound blocks, etc., it is with sufficient use of substitution, deletion, insertion and switching of the various phonemes represented by pictures, sound dots and sound blocks that leads to mastery of the manipulation of phonemes within the spoken syllable. Such mastery is the foundational skill needed to read and spell these syllables and then words via sound and the employment of the sound dot spelling tool, drastically reduces the tendency to misspell individual phoneme grapheme correlates within syllables and words where the alphabetical principal is applied.

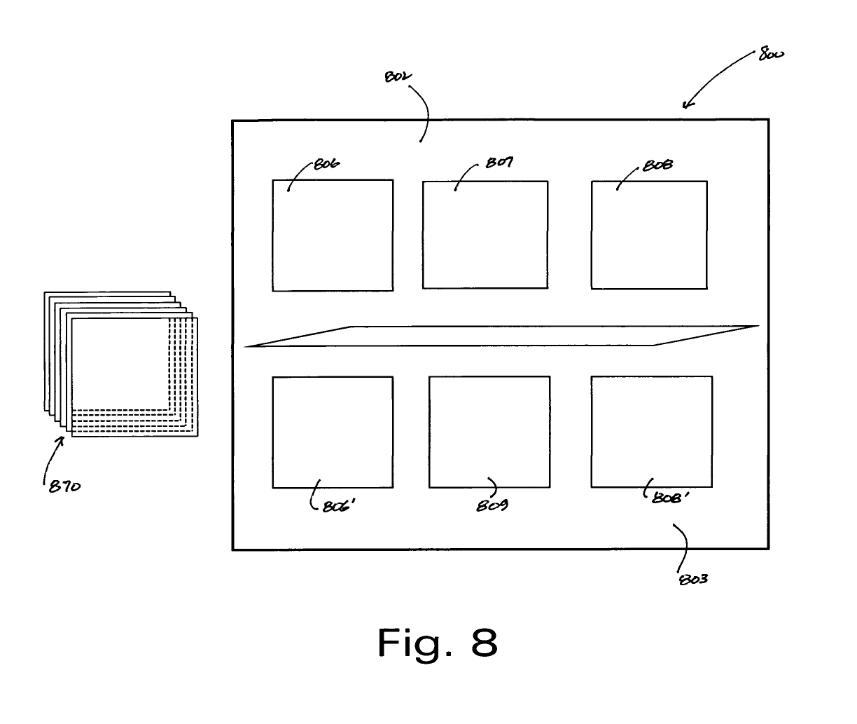

In FIG. 8, word felt game 800 comprises a barrier 802 defining a teacher surface 803 and a student surface 804. A plurality of sound dots are available to both teacher and student. In the example of Fig., teacher side 802 has placed upon it picture cards 806, 807 and 808 wherein: picture card 806 comprises the sound /f/; sound card 807 comprises the picture sound /o/, like ‘ah’; and sound card 808 comprises the picture sound hard /g/. Because teacher surface 802 is a mirror image of student surface 803, for purposes of instruction, the resulting combination of sounds on teacher surface 802 will be formed from right to left as it pertains to the teaching participant. Continuing with the example of FIG. 8, on student surface 803, picture cards 806′, 809 and 808′ proceed from the student participant's left to right. Picture card 809 in this example represents the vowel /i/ in its short vowel sound as in the word “if”.

In the case where the teacher demonstrates her word (or “my word”) as “f-o-g” or the sound of the word “fog” asking the student to form his or her word (“your word”) relative to the teaching participant), to which the student in reply forms the sounds of the word “fig”, the student is asked by the teacher which sound on the teacher surface (only) is the “liar”. Obviously fog and fig are closed syllables identical in the initial consonants and final consonant, but differing in the vowel sound.

Typically, this activity is done with single picture cards, then two picture cards, and then three picture cards. This activity may then be done with single sound dots, two sound dots and then three sound dots. (Do we need to show figures for each of this step?) We can, of course, but can we really address all the permutations and combinations? Probably not.

The student participant may select from a card stack 870 containing a plurality of picture cards, seeking the sound card 807′, representing the identical vowel sound as on teaching surface 802, thereupon replacing picture card 809 upon finding picture card 807′ in said stack of picture cards 870.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure cover the modifications and variations of this disclosure provided they come within the scope of the appended claims and their equivalents.

What is claimed:

1. A method of teaching phonological concepts to students with learning disabilities wherein a teacher employs graphic sound representations rather than letters to teach said students to vocalize the sounds represented in said graphics.

2. The method of claim 1 wherein:
said phonological concepts comprise rhyme, syllable segmentation, syllable blending, syllable deletion, phonemic segmentation, phonemic blending, phonemic deletion, and phonemic substitution.

3. The method of claim 2 wherein:
said student are taught to form syllables and words from one or more of said graphic sound representations, said students further learning to “spell” or vocalize said sounds, syllables and words without the use of conventional letters.

4. The method of claim 3 wherein:
said sound representations comprise pictures of mouth configuration and movement.

5. The method of claim 3 wherein said sound representations comprise sound dots where said sound dots are defined by either of said student or said teacher.

6. The method of claim 3 wherein:
said sound representations comprise sound blocks, said sound blocks defined by either said student or said teacher.

7. The method of claim 4 wherein:
holograms displaying the configuration and movement of a mouth are substituted for said pictures.

8. The method of claim 3 wherein:
said pictures of mouth configuration and movement shown are of the mouth of the student being taught.

9. The method of claim 7 wherein:
said holograms are of the mouth of the student being taught.

10. The method of claim 3 further comprising:
at least one tracking mat.

11. The method of claim 3 further comprising:
at least one spelling mat.

12. The method of claim 3 further comprising:
at least one word mat.

13. The method of claim 10 wherein:
said tracking mat further comprising a substantially flat surface;
at least one anchor point located proximate to the middle of said surface;
a first sound point located on said surface substantially on one side of said anchor point and a second sound point located on said surface substantially on the other side of said anchor point;
a slap point positioned proximate to said anchor point;
a swoop line having two termination points positioned on said surface such that one termination point of said swoop line extends from a position proximate to said first sound point, the other termination point of said swoop line located proximate to said second sound point; and
a reading line positioned on said surface below said swoop line, said reading line being substantially horizontal and straight.

14. The method of claim 13 wherein:
said swoop line having two termination points defining a substantially curved path, said path emanating from a position proximate said first sound point to an area substantially below said anchor point and said slap point, returning and terminating at a position proximate to said second sound point.

15. The method of claim 14 wherein:
said first sound point is green in color and said second sound point is red in color.

16. The tracking mat of claim 13 wherein:
said anchor point and said slap point are distinguishable from one another by graphic design.

17. The method of claim 11 further wherein:
said spelling mat further comprising a substantially flat surface;
at least one anchor point positioned on a predetermined area of said surface; and
at least one slap point positioned on a predetermined area of said surface.

18. The method of 17 wherein:
said surface of said spelling mat having located thereon two or more anchor points; and
said surface of said spelling mat having located thereon two or more slap points, said slap points being equal in number to said anchor points.

19. The method of claim 12 wherein:
said reading mat further comprising a substantially flat surface;
at least one anchor point positioned on a predetermined area of said surface;
at least one sound point positioned on a predetermined area of said surface;
at least one slap point positioned on a predetermined area of said surface; and
a reading line positioned on a predetermined area said surface, said reading line being substantially horizontal.

20. The reading mat of claim 19 wherein:
said reading mat further comprising two or more anchor points and two or more slap points, said slap points being equal in number to said anchor points.

21. The reading mat of claim 19 wherein:
said reading mat further comprising a swoop line defining a substantially curved path, said path emanating from a position proximate to said sound point located leftmost on said surface to an area substantially below said anchor points and said slap points and terminating at a position proximate to said sound point located rightmost on said surface.

22. The reading mat of claim 20 wherein:
said reading mat further comprising a swoop line defining a substantially curved path, said path emanating from a position proximate to said sound point located leftmost on said surface to an area substantially below said anchor points and said slap points and terminating at a position proximate to said sound point located rightmost on said surface.

23. The method of claim 12 wherein:
said word mat having a substantially flat surface; and
at least one sound block to be placed upon said reading mat, said sound block defining a single syllable word.

24. The method of claim 23 wherein:
a plurality of sound blocks may be placed on said surface said blocks' sounds defining a word.

25. The method of claim 23 further comprising:
at least one sound dot, said sound dot comprising the sound representative of said single syllable word.

26. The method of claim 23, further comprising:
a plurality of sound dots, said sound dots in combination forming the consonant and vowel sounds of said single syllable word.

27. The method of claim 13 wherein:
said mat surface is fabricated from felt.

28. The method of claim 18 wherein:
said mat surface is fabricated from felt.

29. The method of claim 22, wherein:
said mat surface is fabricated from felt.

30. The method of claim 24 wherein:
said sound block is fabricated from felt.

31. The method of claim 26 wherein:
said sound dots being fabricated from wood.
